(19) United States
(12) Patent Application Publication
(10) Pub. No.: US 2024/0317158 A1
(43) Pub. Date: Sep. 26, 2024

(54) GROMMET DEVICE AND WIRE HARNESS

(71) Applicant: SUMITOMO WIRING SYSTEMS, LTD., Mie (JP)

(72) Inventor: Kohei HASHIMOTO, Mie (JP)

(21) Appl. No.: 18/271,810

(22) PCT Filed: Jan. 13, 2022
(86) PCT No.: PCT/JP2022/000929

§ 371 Date: Jul. 11, 2023

(30) Foreign Application Priority Data
Jan. 15, 2021 (JP) 2021-005142

(51) Int. Cl. B60R 16/02; F16L 5/10

(52) U.S. Cl. CPC B60R 16/0222; F16L 5/10

(57) ABSTRACT

A grommet device (13) according to an aspect of the present disclosure includes: a bracket (20) that is to be attached to a vehicle body panel (10) and has a plurality of through holes (22) extending in a first direction (X) that intersects a virtual plane (P); a plurality of tubular grommets (30) that are respectively passed through the plurality of through holes (22); and a sealing member (40) that surrounds the plurality of grommets (30) and protrudes from the bracket (20) in the first direction (X) that intersects the virtual plane (P). The plurality of grommets (30) are detachably attached without a gap with respect to each of the through holes (22).

### TECHNICAL FIELD

The present disclosure relates to a grommet device and a wire harness.

### BACKGROUND

Patent Document 1 discloses a grommet to be used in a wire harness. This grommet includes an elastic grommet main body and a hard cover.

The grommet main body includes a plurality of tubular portions through which wires are passed, and a flange portion that extends in a ring shape on the outer side of the plurality of tubular portions. The tubular portions and the flange portion are formed as a single body.

### PRIOR ART DOCUMENT

### Patent Document

Patent Document 1: JP 2007-173139 A

### SUMMARY OF THE INVENTION

### Problems to be Solved

When a wire harness provided with such a grommet is to be manufactured, an operator respectively passes the plurality of wires through the plurality of tubular portions provided as a single body with the flange portion. Then, the operator respectively attaches the plurality of wires to a plurality of connectors. Thus, when attaching a connector to one wire, the operator needs to collectively handle the other wires. Therefore, workability when manufacturing a wire harness may decrease.

The present disclosure aims to provide a grommet device that can improve workability when manufacturing a wire harness and a wire harness.

### Means to Solve the Problem

A grommet device according to the present disclosure is a grommet device to be attached to an attachment target extending along a virtual plane, the grommet device including: a bracket that is to be attached to the attachment target and has a plurality of through holes extending in a direction that intersects the virtual plane; a plurality of tubular grommets that are respectively passed through the plurality of through holes; and a sealing member that surrounds the plurality of grommets and protrudes from the bracket toward the attachment target in the direction that intersects the virtual plane, in which the plurality of grommets are detachably attached without a gap with respect to each of the through holes.

The wire harness according to the present disclosure includes the grommet device and a plurality of wires that are respectively passed through the plurality of grommets.

### Effect of the Invention

With the present disclosure, it is possible to improve workability when manufacturing a wire harness.

### BRIEF DESCRIPTION OF THE DRAWINGS

FIG. 1 is a cross-sectional view showing an embodiment of a grommet device attached to a vehicle body panel.

FIG. 2 is a perspective view showing a grommet device.

FIG. 3 is an exploded perspective view of a grommet device.

### DETAILED DESCRIPTION TO EXECUTE THE INVENTION

### Description of Embodiments of the Present Disclosure

First, aspects of the present disclosure will be listed and described.

A grommet device according to the present disclosure is directed to
[1] a grommet device to be attached to an attachment target extending along a virtual plane, the grommet device including: a bracket that is to be attached to the attachment target and has a plurality of through holes extending in a direction that intersects the virtual plane; a plurality of tubular grommets that are respectively passed through the plurality of through holes; and a sealing member that surrounds the plurality of grommets and protrudes from the bracket toward the attachment target in the direction that intersects the virtual plane, in which the plurality of grommets are detachably attached without a gap with respect to each of the through holes.

With this configuration, it is possible to inhibit foreign matter from entering the attachment target through a space between the grommets and the through holes. Also, a space between the bracket and the attachment target is sealed by attaching the bracket to the attachment target in a state in which the sealing member is pressed against the attachment target. As a result, it is possible to inhibit foreign matter from entering the attachment target through a space between the bracket and the attachment target.

Also, with the above configuration, the grommets are formed separately from the bracket. Thus, even after an operator has passed a wire through a grommet, the operator can handle the wire independently of the other wires.

Therefore, it is possible to improve workability when manufacturing a wire harness.
[2] It is preferable that the grommet includes a tubular portion and a flange portion that protrudes from the tubular portion to an outer circumferential side, in which an outer circumferential surface of the flange portion is provided with a groove portion to which an edge portion of the through hole is fitted.

With this configuration, as a result of the edge portion of the through hole of the bracket being fitted to the groove portion provided in the outer circumferential surface of the flange portion, the grommet can be easily positioned with respect to the bracket in an axial direction of the grommet.
[3] It is preferable that the tubular portion has an accordion structure.

With this configuration, the tubular portion can be easily deformed along a route along which the wire is routed.
[4] It is preferable that the plurality of grommets have the same shape.

With this configuration, the plurality of grommets are interchangeable, reducing the number of types of grommets that constitute the grommet device. Therefore, components can be easily managed.

The wire harness according to the present disclosure includes:
[5] the grommet device; and a plurality of wires that are respectively passed through the plurality of grommets.

With this configuration, it is possible to obtain actions and effects that are similar to actions and effects of the grommet device.

### Details of Embodiments of the Present Disclosure

Specific examples of a grommet device and a wire harness according to the present disclosure will be described below with reference to the following drawings. Portions of configurations may be exaggerated or simplified in the diagrams for convenience in the description. In addition, the ratios between the dimensions shown in the diagrams may be different from each other. Note that the present disclosure is not limited to these examples, and is defined by the claims, and all changes that come within the meaning and range of equivalency of the claims are intended to be embraced therein. Being “orthogonal” as used herein includes not only being strictly orthogonal, but also being generally orthogonal, as long as the actions and effects of this embodiment can be achieved.

### (Basic Configuration of Wire Harness 50)

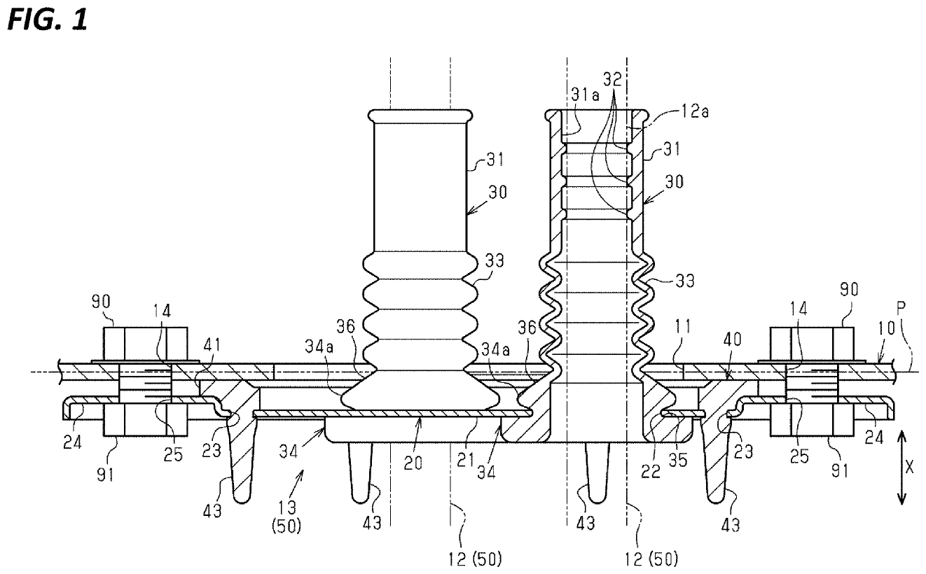

As shown in FIG. 1, a vehicle includes a vehicle body panel 10 that separates the inside and the outside of the vehicle. The vehicle body panel 10 is a panel that is arranged in an engine room or under the floor of the vehicle, for example, and partitions the interior of the vehicle from the exterior thereof, and extends along a virtual plane P. The vehicle body panel 10 corresponds to an attachment target described in “Description of Embodiments of the Present Disclosure”.

Note that a direction orthogonal to the virtual plane P (the up-down direction in FIG. 1) will be described below as a first direction X.

The vehicle body panel 10 is provided with an insertion hole 11 that extends through the vehicle body panel 10 in the first direction X. A wire harness 50 is passed through the insertion hole 11.

The wire harness 50 includes a plurality (three in this embodiment) of wires 12, and a grommet device 13.

Connectors (not shown) are respectively attached to two end portions of each wire 12. The wires 12 electrically connect devices such as an inverter and a motor (these are not shown) mounted in a vehicle, for example.

### (Grommet Device 13)

As shown in FIG. 1, the grommet device 13 seals a space between the wires 12 and a portion of the vehicle body panel 10 that constitutes the insertion hole 11.

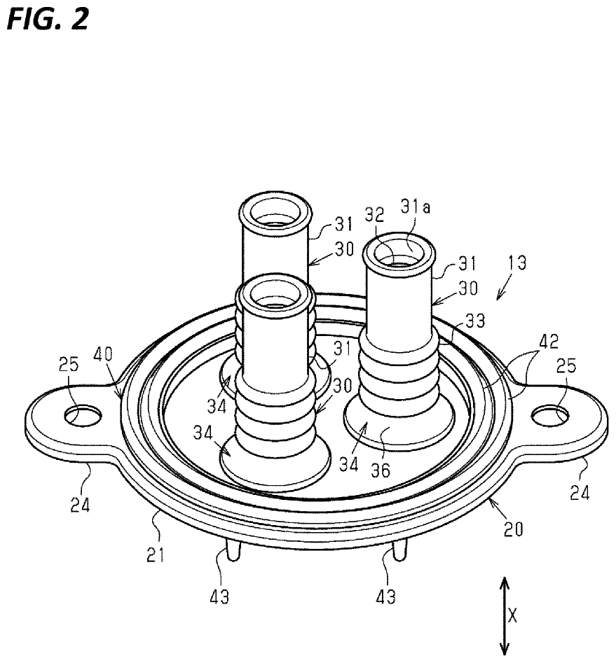

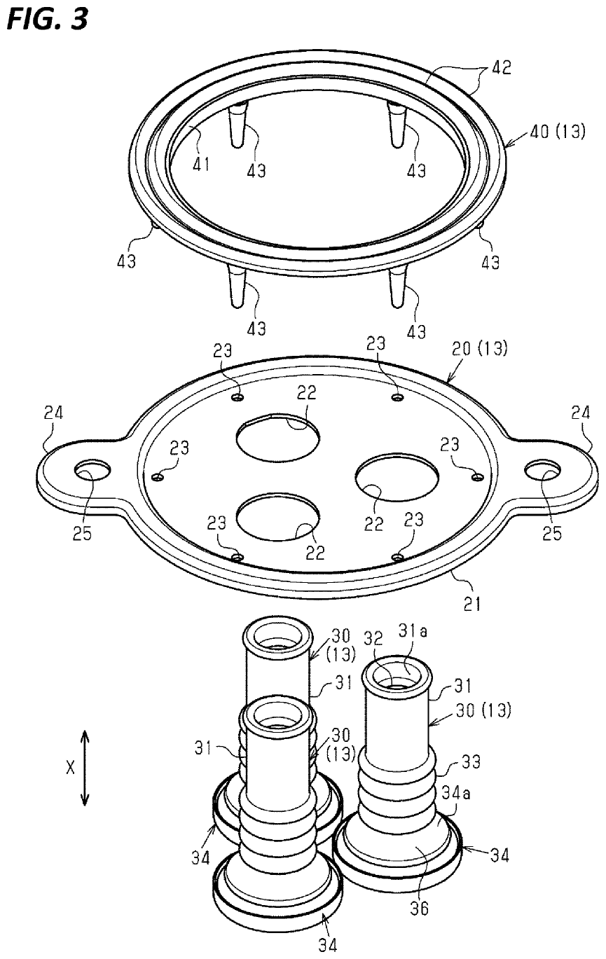

As shown in FIGS. 2 and 3, the grommet device 13 includes the bracket 20, a plurality (three in this embodiment) of tubular grommets 30, and a sealing member 40.

### (Bracket 20)

As shown in FIGS. 1 to 3, the bracket 20 has a disc-shaped main body portion 21, and two fixing portions 24 that extend from the main body portion 21.

As shown in FIG. 3, the main body portion 21 has a plurality of through holes 22 and a plurality of open holes 23. In this embodiment, three through holes 22 are provided. Also, six open holes 23 are provided.

The through holes 22 extend in the first direction X through the main body portion 21. The three through holes 22 are spaced apart from each other.

The open holes 23 extend in the first direction X through the main body portion 21. The open holes 23 are positioned on the outer circumferential side of the main body portion 21 relative to the through holes 22. The six open holes 23 are spaced apart from each other along an outer circumferential edge of the main body portion 21.

As shown in FIG. 1, the two fixing portions 24 protrude from the main body portion 21 outward in the radial direction of the main body portion 21. Each fixing portion 24 has a fastening hole 25 that extends in the first direction X through the fixing portion 24.

It is possible to use a metallic material such as stainless steel or an aluminum alloy as a material of the bracket 20, for example.

### (Grommet 30)

As shown in FIGS. 1 to 3, each grommet 30 has a tubular portion 31 and a flange portion 34 that is continuous with the base end of the tubular portion 31 and protrudes from the tubular portion 31 to the outer circumferential side.

The tubular portion 31 is cylindrical.

A protrusion 32 extends over the entire inner circumferential surface 31a of a leading end portion of the tubular portion 31. Note that three protrusions 32 are spaced apart from each other in the axial direction (first direction X) of the tubular portion 31 in this embodiment. The protrusions 32 contact the outer circumferential surface 12a of the wires 12 through insulation displacement. As a result, the protrusions 32 seal a space between the wire 12 and the grommet 30.

A base end portion of the tubular portion 31 has an accordion structure.

The tubular portion 31 is configured to be able to orient the opening on the leading end side of the tubular portion 31 in a direction that intersects the first direction X through flexible deformation of the accordion structure 33.

A groove portion 35 is provided on the entire outer circumferential surface 34a of the flange portion 34. The outer diameter of the groove portion 35 is slightly larger than the inner diameter of the through hole 22. By fitting an edge portion of the through hole 22 into the groove portion 35, the grommet 30 is detachably attached without a gap with respect to the through hole 22.

A tapered portion 36 is formed in a portion of the flange portion 34 on the leading end side of the flange portion 34 relative to the groove portion 35. The outer diameter of the tapered portion 36 is reduced toward the leading end side.

As shown in FIG. 3, the three grommets 30 have the same shape and are interchangeable. The tubular portion 31 and the flange portion 34 are formed as a single body. It is possible to use an elastic material such as rubber or an elastomer as a material of the grommets 30, for example.

### (Sealing Member 40)

As shown in FIGS. 1 to 3, the sealing member 40 has a circular ring-shaped sealing portion main body 41, and attachment portions 43. The sealing member 40 is provided separately from the bracket 20.

The inner diameter of the sealing portion main body 41 is larger than the inner diameter of the insertion hole 11 (see FIG. 1). The outer diameter of the sealing portion main body 41 is smaller than the outer diameter of the main body portion 21 of the bracket 20 (see FIG. 2).

As shown in FIGS. 2 and 3, the sealing portion main body 41 has two circular ring-shaped lip portions 42. The lip portions 42 protrude from one surface of the sealing portion main body 41, that is, a surface of the sealing portion main body 41 facing the vehicle body panel 10. The two lip portions 42 are provided concentrically with the sealing portion main body 41.

As shown in FIGS. 1 and 3, the attachment portions 43 protrude from the other surface of the sealing portion main body 41, that is, a surface of the sealing portion main body 41 facing the bracket 20. The attachment portions 43 are tapered conical. In this embodiment, six attachment portions 43 are provided at positions that correspond to the positions of the six open holes 23. The sealing portion main body 41 and the attachment portions 43 are formed as a single body. It is possible to use an elastic material such as rubber or an elastomer as a material of the sealing member 40, for example.

The attachment portions 43 are respectively passed through the open holes 23 without a gap. As a result, the sealing member 40 is attached to the bracket 20.

The sealing portion main body 41 protrudes from the bracket 20 in the first direction X in a state in which the sealing member 40 is attached to the bracket 20. Also, the sealing portion main body 41 collectively surround the three grommets 30.

As shown in FIG. 1, the grommet device 13 is attached to the vehicle body panel 10 by inserting screws 90 into holes 14 of the vehicle body panel 10 and the fastening holes 25, and screwing the screws 90 into nuts 91 arranged below the fixing portion 24. At this time, the main body portion 21 of the bracket 20 covers the entire insertion hole 11 from below. Also, the lip portions 42 contact the vehicle body panel 10 through insulation displacement. Note that the screws 90 may be fixed to the vehicle body panel 10 in advance, or the nuts 91 may be fixed to the bracket 20 in advance. Also, the screws 90 and the nuts 91 need not be fixed in advance.

As shown in FIGS. 1 and 3, a portion of the main body portion 21 of the bracket 20 covering the entire insertion hole 11 need not have holes or cuts other than the plurality of through holes 22.

As shown in FIG. 1, when the bracket 20 fixed to the vehicle body panel 10 is viewed in the thickness direction of the bracket 20, the open holes 23 may be located outward of the insertion holes 11, and the through holes 22 may be located inward of the insertion holes 11.

As shown in FIG. 1, in a state in which the grommet 30 is attached to the through hole 22, the flange portion 34 may contact one surface of the bracket 20 in the thickness direction of the main body portion 21 through insulation displacement (e.g., a lower surface or a surface on the exterior side in FIG. 1). As shown in FIG. 3, the flange portion 34 may have a circular ring-shaped sealing lip configured to come into elastically intimate contact with the main body portion 21.

As shown in FIG. 1, in a state in which the bracket 20 is fixed to the vehicle body panel 10, the sealing portion main body 41 may be held between one surface of the bracket 20 in the thickness direction of the main body portion 21 (e.g., an upper surface or a surface on the interior side in FIG. 1) and the vehicle body panel 10 so as to surround the insertion holes 11. The maximum outer diameter of the attachment portion 43 may be slightly larger than the inner diameter of the open hole 23.

Actions and effects of this embodiment will be described.
(1) The grommet device 13 includes the bracket 20 having the plurality of through holes 22, the plurality of grommets 30 that are respectively passed through the plurality of through holes 22, and the sealing member 40 that surrounds the plurality of grommets 30. The plurality of grommets 30 are detachably attached without a gap with respect to each of the through holes 22.

With this configuration, it is possible to inhibit foreign matter from entering the vehicle body panel 10 through a space between the grommets 30 and the through holes 22. Also, by attaching the bracket 20 to the vehicle body panel 10 in a state in which the sealing member 40 is pressed against the vehicle body panel 10, a space between the bracket 20 and the vehicle body panel 10 is sealed. As a result, it is possible to inhibit foreign matter from entering the vehicle body panel 10 through a space between the bracket 20 and the vehicle body panel 10.

Also, with the above configuration, the grommets 30 are formed separately from the bracket 20. Therefore, even after an operator has passed a wire 12 through a grommet 30, the operator can handle the wire 12 independently of the other wires 12.

Therefore, it is possible to improve workability when manufacturing the wire harness 50.
(2) Each grommet 30 has a tubular portion 31 and a flange portion 34 that protrudes from the tubular portion 31 to the outer circumferential side. The outer circumferential surface 34a of the flange portion 34 has the groove portion 35 to which the edge portion of the through hole 22 is fitted.

With this configuration, as a result of the edge portion of the through hole 22 of the bracket 20 being fitted to the groove portion 35 provided in the outer circumferential surface 34a of the flange portion 34, the grommet 30 can be easily positioned with respect to the bracket 20 in the axial direction of the grommet 30.

When the grommet 30 has the groove portion 35, an insertion load is generated when a portion of the flange portion 34 on the leading end side relative to the groove portion 35 passes through the through hole 22. Therefore, workability when inserting the grommet 30 into the through hole 22 may decrease.

In this respect, according to the above configuration, the above portion is provided with the tapered portion 36, and thus, the portion can be inserted into the through hole 22 while the portion is gradually elastically deformed. As a result, the insertion load of the grommet 30 on the through hole 22 is reduced. Therefore, the grommet 30 can be easily inserted into the through hole 22 while the groove portion 35 is provided.
(3) The tubular portion 31 has the accordion structure 33.

With this configuration, the tubular portion 31 can be easily deformed along the route along which the wire 12 is routed.
(4) The plurality of grommets 30 have the same shape.

With this configuration, the plurality of grommets 30 are interchangeable, reducing the number of types of grommets 30 that constitute the grommet device 13. Therefore, components can be easily managed.

### MODIFICATION EXAMPLES

This embodiment can be modified and implemented as follows. This embodiment and the following modification examples may be combined and implemented to the extent that they do not contradict each other technically.
The number of protrusions 32 is not limited to the number listed as an example in this embodiment. That is to say, the number of protrusions 32 may be one, two, or four or more.
The protrusions 32 may be omitted. In this case, a space between the inner circumferential surface 31a of the tubular portion 31 and the wire 12 may be sealed by bringing the inner circumferential surface 31a into contact with the wire 12 or providing a sealing member that is separate from the grommet 30.
The number of through holes 22 and the number of grommets 30 are not limited to the numbers listed as examples in this embodiment, and may be changed as appropriate according to the number of wires 12 routed in a vehicle through the insertion hole 11.
The grommets 30 is not limited to having the same shape as those mentioned as an example in this embodiment. The inner diameters of the plurality of grommets 30 can also be changed as appropriate according to the outer diameters of the corresponding wires 12 to be passed through the grommets 30.
The accordion structure 33 may be omitted. Even in this case, the grommets 30 are preferably configured to be able to flexibly deform.
The tapered portion 36 of the flange portion 34 may be omitted.
The groove portion 35 of the flange portion 34 may be omitted. In this case, it is sufficient to attach the outer circumferential surface of the flange portion 34 without a gap with respect to the through hole 22.
The flange portion 34 may be omitted. In this case, a groove portion to which the edge portion of the through hole 22 is fitted may be provided in the outer circumferential surface of the tubular portion 31. Also, the outer circumferential surface of the tubular portion 31 may be attached without a gap with respect to the through hole 22.
The sealing member 40 is not limited to a sealing member molded separately from the bracket 20 as mentioned as an example in this embodiment, and the sealing member 40 may be molded as a single body with the bracket 20 by inserting the bracket 20. In this case, the attachment portion 43 can be omitted.
The grommet 30 in this embodiment may be referred to as an elastic resin water-stopping tube. The sealing member 40 in this embodiment may be referred to as a sealing ring. The flange portion 34 or the groove portion 35 of the grommet 30 in this embodiment may be referred to as an elastic resin fitting configured to come into contact with the bracket 20 in a water-stopping manner. The through hole 22 of the bracket 20 in this embodiment may be referred to as a tube mounting hole to which the flange portion 34 or the groove portion 35 of the grommet 30 is fitted. The main body portion 21 of the bracket 20 in this embodiment may be referred to as a metal plate.

The present disclosure encompasses any combination of the following constituent elements. Not for limitation but for assistance in understanding, reference numerals are provided.

### APPENDIX 1

An aspect of the present disclosure is directed to the grommet device 13 for use together with the plurality of wires 12 and the vehicle body panel 10 having the insertion hole 11,
the grommet device 13 can include:
a plurality of elastic resin water-stopping tubes 30 configured to respectively support the plurality of wires 12 in a water-stopping manner;
a metal bracket 20 configured to support the plurality of elastic resin water-stopping tubes 30; and
a sealing ring 40 that is supported by the metal bracket 20 and configured to seal a space between the metal bracket 20 and the vehicle body panel 10 in a water-stopping manner,
in which each of the plurality of elastic resin water-stopping tubes 30 can include elastic resin fittings 34 and 35 configured to come into contact with the metal bracket 20 in a water-stopping manner, and
the elastic resin fittings 34 and 35 of the plurality of elastic resin water-stopping tubes 30 may be configured to allow the plurality of elastic resin water-stopping tubes 30 to be individually and independently detachable from the metal bracket 20.

### APPENDIX 2

In several aspects of the present disclosure, the metal bracket 20 can include the metal plate 21 having a plurality of tube mounting holes 22 that respectively correspond to the elastic resin fittings 34 and 35 of the plurality of elastic resin water-stopping tubes 30, the metal plate 21 being larger than the insertion hole 11 of the vehicle body panel 10.

### APPENDIX 3

In several aspects of the present disclosure, each elastic resin water-stopping tube 30 can have a length defined by a base end and a leading end thereof, and the elastic resin fittings 34 and 35 of the plurality of elastic resin water-stopping tubes 30 may be provided at the base end of the elastic resin water-stopping tubes 30.

### APPENDIX 4

In several aspects of the present disclosure, each elastic resin water-stopping tube 30 can include
a base-end tubular portion 34, leading-end tubular portions 31 and 32, and an intermediate accordion portion 33 located between the base-end tubular portion 34 and the leading-end tubular portion 31,
the leading-end tubular portions 31 and 32 of each elastic resin water-stopping tube 30 can include a sealing protrusion 32 configured to be able to come into contact with an outer circumferential surface of the corresponding wire 12,
the base-end tubular portions 34 and 35 of each elastic resin water-stopping tube 30 can include the elastic resin fittings 34 and 35, and
the intermediate accordion portion 33 of each elastic resin water-stopping tube 30 may be configured to allow movement of the leading-end tubular portions 31 and 32 relative to the base-end tubular portions 34 and 35.

### LIST OF REFERENCE NUMERALS

P Virtual plane
X First direction
10 Vehicle body panel
11 Insertion hole
12 Wire
12a Outer circumferential surface
13 Grommet device
14 Hole
20 Bracket
21 Main body portion
22 Through hole
23 Open hole
24 Fixing portion
25 Fastening hole
30 Grommet
31 Tubular portion
31a Inner circumferential surface
32 Protrusion
33 Accordion structure
34 Flange portion
34a Outer circumferential surface
35 Groove portion
36 Tapered portion
40 Sealing member
41 Sealing portion main body
42 Lip portion
43 Attachment portion
50 Wire harness
90 Screw
91 Nut

1. A grommet device to be attached to an attachment target extending along a virtual plane, the grommet device comprising:
a bracket that is to be attached to the attachment target and has a plurality of through holes extending in a direction that intersects the virtual plane;
a plurality of tubular grommets that are respectively passed through the plurality of through holes; and
a sealing member that surrounds the plurality of grommets and protrudes from the bracket toward the attachment target in the direction that intersects the virtual plane,
wherein the plurality of grommets are detachably attached without a gap with respect to each of the through holes.

2. The grommet device according to claim 1,
wherein the grommet includes a tubular portion and a flange portion that protrudes from the tubular portion to an outer circumferential side,
wherein an outer circumferential surface of the flange portion is provided with a groove portion to which an edge portion of the through hole is fitted.

3. The grommet device according to claim 2,
wherein the tubular portion has an accordion structure.

4. The grommet device according to claim 1,
wherein the plurality of grommets have the same shape.

5. A wire harness comprising:
the grommet device according to claim 1; and
a plurality of wires that are respectively passed through the plurality of grommets.
